(19) United States
(12) Patent Application Publication
(10) Pub. No.: US 2007/0052814 A1
(43) Pub. Date: Mar. 8, 2007

(54) Method and Apparatus for white-balancing an image

(76) Inventor: Tirumala R. Ranganath, Palo Alto, CA (US)

Correspondence Address: AVAGO TECHNOLOGIES, LTD., P.O. BOX 1920, DENVER, CO, 80201-1920, US

(21) Appl. No.: 11/221,170

(22) Filed: Sep. 7, 2005

(51) Int. Cl. H04N 9/73

(52) U.S. Cl. 348/223.1

(57) ABSTRACT

Method and apparatus for white-balancing an image of an object. Light reflected from the object illuminated with light having known spectral characteristics is collected, and the spectral reflectivity characteristics of the object is determined from the collected light. Light reflected from the object illuminated with light having unknown spectral characteristics is collected to form an image of the object, and the formed image is white-balanced in accordance with the determined spectral reflectivity characteristics of the object.

### DESCRIPTION OF RELATED ART

The spectral distribution of different light sources can vary significantly such that pictures taken of the same object under different lighting conditions may appear quite different from one another. An incandescent lamp light source, for example, will produce a picture that appears to be warmer (redder) than it actually is, because the fraction of blue and green photons coming out of the lamp are less than they would be for light from a more natural light source such as sun light.

In an electronic camera, color information is recorded separately for each primary color, i.e., there are separate sub-pixels for red, green and blue at each pixel location on a light sensor of the camera. In order to accurately depict the color of an object photographed with an electronic camera, it is necessary to balance the colors of each sub-pixel at a pixel location in the correct proportion to account for the particular light source that was used to illuminate the object. Because a picture of a white object such as a piece of white paper may appear yellow as a result of the colors of the sub-pixels being incorrectly balanced, the process of bringing the color of the paper back to white and, in general, of correcting the color of a picture, is referred to as “white-balancing”.

In an electronic camera, a picture can be white-balanced by electronically changing the colors corresponding to different sub-pixels. This can be done by taking a picture of a white paper, and determining the scale factors needed to make the white balance come out correctly from information gathered about the picture. Alternatively, a camera can be provided with a “built-in” color correction capability such that an operator can indicate the illumination source type being used prior to taking a picture.

### SUMMARY OF THE INVENTION

In accordance with the invention, a method and apparatus for white-balancing an image of an object is provided. Light reflected from the object illuminated with light having known spectral characteristics is collected, and the spectral reflectivity characteristics of the object is determined from the collected light. Light reflected from the object illuminated with light having unknown spectral characteristics is collected to form an image of the object, and the formed image is white-balanced in accordance with the determined spectral reflectivity characteristics of the object.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1 is a diagram that schematically illustrates a digital camera and an object to be photographed with the digital camera according to an exemplary embodiment in accordance with the invention;

FIG. 2 schematically illustrates a light sensor in the digital camera illustrated in FIG. 1; and

FIG. 3 is a flowchart that illustrates a method for white-balancing an image of an object according to an exemplary embodiment in accordance with the invention.

### DETAILED DESCRIPTION OF THE EXEMPLARY EMBODIMENTS OF THE INVENTION

Exemplary embodiments in accordance with the invention provide a method and apparatus for white-balancing an image of an object.

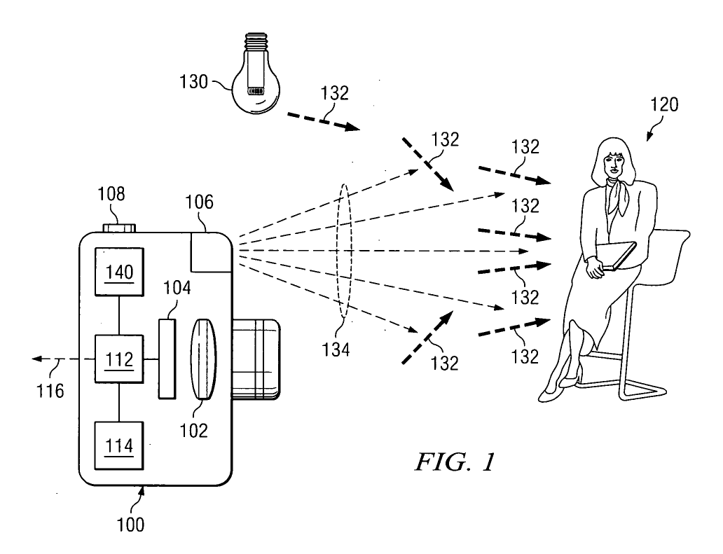

FIG. 1 is a diagram that schematically illustrates a digital camera and an object to be photographed with the digital camera according to an exemplary embodiment in accordance with the invention. The digital camera is generally designated by reference number 100, and includes lens 102, light sensor 104, flash unit 106, shutter button 108, image processor 112 and memory 114.

When using digital camera 100 to take a picture of an object, such as object 120 in FIG. 1, a framing unit, not shown in FIG. 1, is used by an operator of camera 100 to compose a scene that includes object 120. When a desired scene has been framed, the operator takes a picture of the framed scene by depressing shutter button 108. Lens 102 collects light reflected from object 120 and forms an image of the object on light sensor 104, which may, for example, comprise a CCD (Charge-Coupled Device) or a CMOS (Complementary Metal Oxide Semiconductor) light sensor. During the photographing operation, the object may be illuminated by ambient light 132 from one or more ambient light sources, generally represented by ambient light source 130 in FIG. 1, or by light 134 from flash unit 106 depending on the environment in which the picture is to be taken or the preference of the operator. Flash unit 106 may be built-in camera 100 as shown in FIG. 1, or may be a separate component linked to the camera.

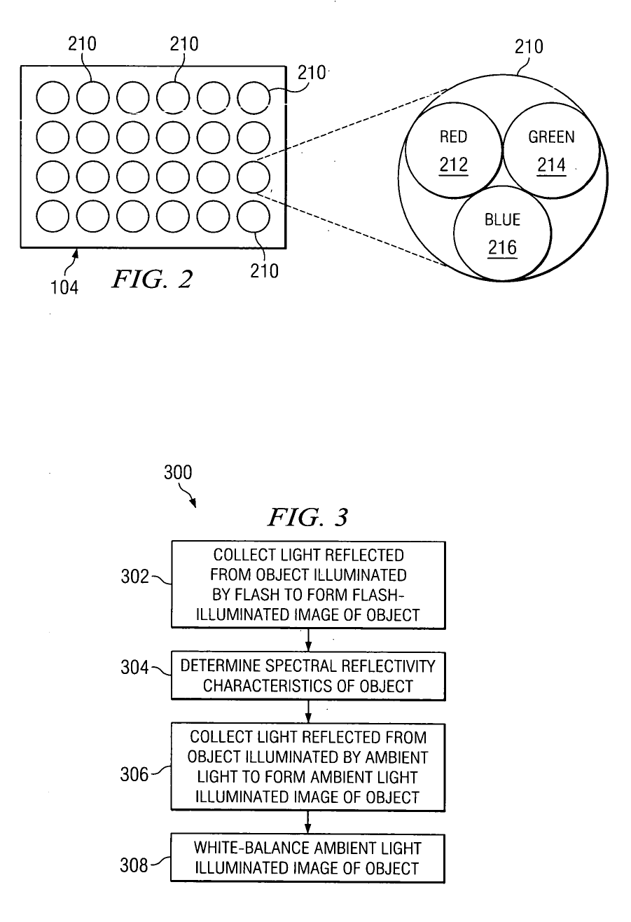

FIG. 2 schematically illustrates a light sensor in the digital camera illustrated in FIG. 1. As shown, light sensor 104 includes an array of pixel locations 210 (greatly enlarged in FIG. 2), each of which is comprised of a plurality of sub-pixels 212, 214 and 216. Sub-pixels 212, 214 and 216 at each pixel location 210 comprise sub-pixels of a different one of primary colors red, green and blue, respectively; and color information regarding a photographed scene is recorded separately for each primary color by light sensor 104.

Since what is actually measured in digital camera 100 is the charge generated in each sub-pixel for its associated color, the color of a photographed scene can be altered by electronically changing the color corresponding to each sub-pixel at a pixel location using image processor 112. Image processor 112 may be built-in camera 100 as shown in FIG. 1, or provided separate from the camera. As will be explained in detail hereinafter, according to exemplary embodiments in accordance with the invention, image processor 112 comprises a white-balancing mechanism for white-balancing the color of a picture taken with digital camera 100 under ambient light conditions.

In particular, in order to accurately depict the color of an object photographed with an electronic camera, such as digital camera 100 in FIG. 1, it is necessary to balance the colors of the light received by each sub-pixel at each pixel location of light sensor 112 of the camera in the correct proportion in order to account for the particular light source that illuminates the object during the photographing operation. Because a picture of a white object such as a piece of white paper may appear yellow as a result of the colors of the sub-pixels being incorrectly balanced, the process of bringing the color of the white paper back to white and, in general, of correcting the color of the picture, is referred to as “white-balancing”.

White-balancing is necessary to accurately depict the color of a photographed object because the spectral characteristics of light from different light sources can differ significantly such that photographs taken of the same object under different lighting conditions may appear quite different from one another. The object being photographed may, for example, be illuminated by ambient light from an incandescent light source, a fluorescent light source, a candle, sunlight or another light source or combination of light sources. Each different light source type has different spectral characteristics, such that the color of an image of the object may not accurately reflect the actual color of the object.

According to exemplary embodiments in accordance with the invention, an image of an object is white-balanced by determining the spectral reflectivity characteristics of the object, and then white-balancing the image in accordance with the spectral reflectivity characteristics of the object.

Referring back to FIG. 1, in order to white-balance an image of object 120 formed on light sensor 104 during a photographing operation, according to exemplary embodiments in accordance with the invention, an operator of digital camera 100 first takes a picture of the object while the object is illuminated with a very bright, very short burst of light from a light source having known spectral characteristics. By making the burst of light very bright and very short, the effect of any ambient light that may also be illuminating the object is minimized so that an image of the object formed on light sensor 104 will primarily be a function of the spectral characteristics of the light source having known spectral characteristics and the spectral reflectivity characteristics of the object. Because the spectral characteristics of the light from the light source is known, the spectral reflectivity characteristics of the object can be determined by deconvolving, i.e., removing the effects of, the spectral characteristics of the light from the light source from the collected light signal reflected from the object. The determined spectral reflectivity characteristics of the object is then used to color-balance an image of the object taken by the camera under ambient light conditions.

In accordance with an exemplary embodiment in accordance with the invention, the light source emitting light having known spectral characteristics is flash unit 106 that is already provided in digital camera 100. Specifically, flash units that are currently built-in or otherwise linked to digital cameras produce a pulse of light having a very short duration of, for example, from less than about 1.0 to about 3.0 milliseconds, and is sufficiently bright to minimize the effect of any ambient light that may also illuminate the object. It should be understood, however, that the invention is not limited to use of any particular light source emitting light of known spectral characteristics, and other light sources can also be used, if desired.

The spectral characteristics of the light emitted by flash unit 106 is known by the manufacturer of the flash unit and/or of the camera, and can be stored in memory 114, for example, a RAM (Random Access Memory), provided in camera 100. When object 120 is illuminated with light from flash unit 106, the light reflected from the object is collected and focused onto light sensor 104 by lens 102 to form an image of object 120 on light sensor 104. The color of the image, as detected by individual pixels 212, 214 and 216 at each pixel location 210 is a function of both the spectral characteristics of light 134 from flash unit 106, and the spectral reflectivity characteristics of object 120. Since the spectral characteristics of the illuminating light 134 is known and stored in memory 114, its effects are removed from the received light signal by image processor 112 to permit the spectral reflectivity characteristics of the object to be determined. The determined spectral reflectivity characteristics of the object is also stored in memory 114.

A picture is then taken of object 120 under ambient light conditions wherein the object is illuminated by light having unknown spectral characteristics. Light reflected from the object is collected by lens 102 and an image of the object is formed on light sensor 104. Since the spectral reflectivity characteristics of the object is now known and stored in memory 114, image processor 112 is able to use this information to correctly balance the colors of each sub-pixel at each pixel location on light sensor 104 in the correct proportion to account for the spectral characteristics of the ambient light that illuminated the object during the photographing operation, to produce a picture, generally represented by arrow 116, that accurately represents the color of the object.

Typically, white-balancing is done by boosting and/or reducing the strength of one or more of the sub-pixels at one or more pixel locations. In particular, the picture taking process can be symbolically represented by the following equation:
[Rij]=Ired [Aij]+Igreen [Bij]+Iblue [Cij]
where Rij is the response of the composite pixel location “ij”, and Ired, Igreen and Iblue are the red, green and blue illumination source functions. Aij, Bij and Cij are the reflecting functions of the object that contribute to light arriving at pixel location “ij”.

Since the illumination source functions Ired, Igreen and Iblue are known, they can be deconvolved from the response Rij permitting the reflecting functions Aij, Bij and Cij to be determined. This information is then used to determine the fraction of the signal received at each sub-pixel that is due to the strength of the ambient light that illuminates the object and to white-balance the picture of the object by adjusting the strength of each pixel to remove the effect of the ambient light from the signal.

According to an exemplary embodiment in accordance with the invention, the actual picture of the object under ambient light conditions is taken substantially immediately after the picture is taken using the flash unit so that the object will not have moved (if it is a movable object) or otherwise changed in such a way that might alter its spectral reflectivity characteristics. It should be understood, however, that the invention is not limited to any particular timing between taking the picture under known lighting conditions and under ambient lighting conditions, or to any particular order in which the pictures are taken.

In accordance with exemplary embodiments in accordance with the invention, an image of an object can be white-balanced quickly and accurately without involvement of the operator of the camera. In addition, the method and apparatus according to exemplary embodiments of the invention make use of the light sensor and flash unit that are already present in most digital cameras, and, thus, the present invention adds very little to the overall cost of the camera.

As a flash unit ages, its spectral characteristics may change with time which may result in the white-balancing algorithm used by image processor 112 to white-balance an image degrading over time. This can be countered by providing a calibration mechanism, schematically designated by reference number 140 in FIG. 1, in camera 100 to enable the spectral characteristics of the flash unit to be changed to reflect the current state of the flash unit. Specifically, an operator can periodically, for example, once every two hundred pictures or so, take a picture of a white sheet of paper and make any necessary corrections to the stored information regarding the spectral characteristics of the flash unit using calibration mechanism 140. The camera could be provided with a prompt, if desired to advise the operator when the calibrations are due to be made.

FIG. 3 is a flowchart that illustrates a method for white-balancing in image of an object according to an exemplary embodiment in accordance with the invention. The method is generally designated by reference number 300, and begins by collecting light reflected from the object while the object is illuminated by a short, bright burst of light from a flash unit that emits light having known spectral characteristics (Step 302). The spectral reflectivity characteristics of the object are then determined by deconvolving the known spectral characteristics of the flash unit from the collected light (Step 304). Light reflected from the object illuminated by ambient light having unknown spectral characteristics is then collected to provide an ambient light illuminated image of the object (Step 306), and the image is white-balanced in accordance with the spectral reflectivity characteristics of the object to provide a white-balanced image of the object (Step 308).

While what has been described constitute exemplary embodiments in accordance with the invention, it should be recognized that the invention can be varied in numerous ways without departing from the scope thereof. Because exemplary embodiments in accordance with the invention can be varied in numerous ways, it should be understood that the invention should be limited only insofar as is required by the scope of the following claims.

I claim:

1. A method for white-balancing an image of an object, comprising:
collecting light reflected from an object illuminated with light having known spectral characteristics;
determining spectral reflectivity characteristics of the object from the collected light reflected from the object illuminated with light having known spectral characteristics;
collecting light reflected from the object illuminated with light having unknown spectral characteristics to form an image of the object; and
white-balancing the formed image of the object in accordance with the spectral reflectivity characteristics of the object.

2. The method according to claim 1, wherein collecting light reflected from an object illuminated with light having known spectral characteristics, comprises:
collecting light reflected from an object illuminated with a bright pulse of light of short duration.

3. The method according to claim 2, wherein collecting light reflected from an object illuminated with a bright pulse of light of short duration, comprises:
collecting light reflected from an object illuminated with light from a flash unit of a camera.

4. The method according to claim 3, wherein the camera comprises a digital camera.

5. The method according to claim 3, and further including:
storing the known spectral characteristics of the light from the flash unit in a memory.

6. The method according to claim 5, and further including:
periodically calibrating the spectral characteristics of the flash unit stored in the memory.

7. The method according to claim 1, wherein determining spectral reflectivity characteristics of the object from the collected light reflected from the object illuminated with light having known spectral characteristics, comprises:
deconvolving the spectral characteristics of the light having known spectral characteristics from the collected light reflected from the object illuminated with light having known spectral characteristics.

8. The method according to claim 1, wherein collecting light reflected from the object illuminated with light having unknown spectral characteristics to form an image of the object, comprises:
forming an image of the object on a light sensor, and wherein white-balancing the formed image in accordance with the spectral reflectivity characteristics of the object, comprises:
adjusting the strength of one or more sub-pixels at one or more pixel locations on the light sensor, wherein each sub-pixel at a pixel location comprises a sub-pixel of a different color.

9. The method according to claim 1, wherein collecting light reflected from the object illuminated with light having unknown spectral characteristics to form an image of the object, comprises:
collecting light reflected from the object illuminated with ambient light to form an image of the object.

10. The method according to claim 9, wherein the ambient light comprises at least one of light from an incandescent light source, a fluorescent light source, a candle or the sun.

11. An apparatus for white-balancing an image of an object, comprising:
a light source providing light having known spectral characteristics; and
an image processor, wherein the image processor:
determines spectral reflectivity characteristics of an object from collected light reflected from the object while illuminated by the light having known spectral characteristics; and
white-balances an image of the object from light collected from the object while illuminated by light having unknown spectral characteristics in accordance with the spectral reflectivity characteristics of the object.

12. The apparatus according to claim 11, wherein the light source comprises a flash unit.

13. The apparatus according to claim 12, and further comprising a memory for storing the known spectral characteristics of the flash unit.

14. The apparatus according to claim 13, and further comprising a calibration mechanism for periodically calibrating the known spectral characteristics of the flash unit stored in the memory.

15. The apparatus according to claim 11, wherein the apparatus comprises an electronic camera.

16. The apparatus according to claim 15, wherein the electronic camera comprises a digital camera.

17. An electronic camera, comprising:
a flash unit for illuminating an object to be photographed, the flash unit providing light having known spectral characteristics;
a light sensor for receiving an image of the object, the light sensor including a plurality of pixel locations, each pixel location including a sub-pixel of a different primary color; and
an image processor for white-balancing the image of the object in accordance with the spectral reflectivity characteristics of the object.

18. The camera according to claim 17, and further including a memory for storing the known spectral characteristics of the flash unit.

19. The camera according to claim 18, and further including a calibration mechanism for calibrating the stored spectral characteristics of the flash unit.

20. The camera according to claim 17, wherein the electronic camera comprises a digital camera.
